(19) United States
(12) Patent Application Publication
(10) Pub. No.: US 2019/0289867 A1
(43) Pub. Date: Sep. 26, 2019

(54) METHOD OF CONVERTING LACTOSE-CONTAINING DAIRY BY-PRODUCTS INTO MONOSACCHARIDES

(71) Applicant: Wisconsin Alumni Research Foundation, Madison, WI (US)

(72) Inventors: George W. Huber, Middleton, WI (US); Scott A. Rankin, Cross Plains, WI (US); Mark J. Lindsay, Madison, WI (US)

(21) Appl. No.: 15/926,461

(22) Filed: Mar. 20, 2018

(51) Int. Cl. A23C 9/142; C13K 13/00; C13K 1/00; B01J 20/20; B01J 21/02; B01J 21/06; B01J 21/08; B01J 21/16; B01J 27/053; B01J 27/06; B01J 27/16; B01J 27/24; B01J 29/04

(52) U.S. Cl. CPC A23C 9/1425; A23V 2300/50; C13K 1/00; B01J 20/20; B01J 21/02; B01J 21/066; B01J 21/08; B01J 21/16; B01J 27/053; B01J 27/06; B01J 27/16; B01J 27/24; B01J 29/04; A23C 2210/206; A23V 2002/00; A23V 2250/608; A23V 2250/61; A23V 2300/02; A23V 2300/28; C13K 13/00

(57) ABSTRACT

A method of making a solution containing glucose and galactose. The method includes the steps of reducing the concentration of non-protein nitrogen-containing (NPN) compounds in a dairy by-product stream comprising lactose to yield a reduced-NPN dairy by-product stream; and contacting the reduced-NPN dairy by-product stream of step (a) with an acid catalyst at a temperature of from about 120° C. to about 200° C., and for a time of from about 1 minute to about 180 minutes, wherein at least a portion of the lactose contained in the reduced-NPN dairy by-product stream is hydrolyzed to monosaccharides comprising glucose and galactose. The dairy by-product stream may be ultrafiltered prior to reducing its NPN concentration.

### BACKGROUND

Dairy product manufacturing processes generate waste streams characterized by dilute aqueous solutions of lactose, proteins, non-protein nitrogen (NPN) species, minerals, fats, and various solids. See, for example, Blaschek et al. Journal of dairy science, 2007, 90, 2029-2034. Whey, a common dairy waste stream, generally falls into two categories: sweet whey (a product of cheese and yogurt manufacturing) and acid whey (a product of cottage cheese and Greek yogurt manufacturing). (Id.) While both sweet and acid whey contain roughly 94 wt % water and 4.5 wt % lactose, acid whey has higher acid content than sweet whey (pH range of 4.3-5.1 and 5.9-6.6 for acid and sweet whey respectively) and acid whey from Greek yogurt has less protein than sweet whey (0.1 wt % and 0.6 wt % for Greek yogurt acid whey and sweet whey respectively). (G. Bylund, Dairy Processing Handbook 2^{nd} Ed., ©2015, Tetra Pak Filtration Solutions, Silkeborg, Denmark, ISBN 978-9176111321.) From 2007 to 2015, the US market share of Greek yogurt increased from 1% to nearly 40% for a total of 770,000 metric tons of Greek yogurt per year. See M. Astley, Greek yogurt waste ‘acid whey’ a concern for USDA: Jones Laffin; DairyReporter.com (Jan. 31, 2014), https://www.dairyreporter.com/Article/2014/01/30/Greek-yogurt-waste-acid-whey-a-concern-for-USDA-Jones-Laffin. This rise has been accompanied by an even greater increase in acid whey production: up to approximately four million tons per year⁶. Whereas 70% of the sweet whey generated in cheese production is utilized for products such as whey protein and pure lactose, the utilization of acid whey is limited, causing dairy producers to send acid whey to waste water treatment facilities or to farmers who spread it on their fields, or to feed it to their livestock. These disposal methods cost the dairy manufacturers and harm the environment in the form of unproductive land and water pollution resulting in fish kills. (Id.) Additionally, the water, energy, and carbon footprints associated with wasted acid whey totals three hundred twenty million tons of water, two billion kilowatts of energy, and five hundred thousand tons of CO₂ emissions per year in the US (calculated using inputs from production volumes, USDA—National Agricultural Statistics Service (NASS). Statistics by Subject, https://www.nass.usda.gov/Statistics_by_Subject/index.php?sector=ANIMALS %20&%2 0PRODUCTS and resource consumption, A. Park and J. Lurie (Mar. 10, 2014), It Takes HOW Much Water to Make Greek Yogurt?!, http://www.motherjones.com/environment/2014/03/california-water-suck/).

Conventional commercial approaches to extract whey protein and lactose from sweet whey typically involve ultrafiltration, which separates the whey into protein-rich retentate and protein-free permeate fractions. M. G. Siso, Bioresource technology, 1996, 57, 1-11. The retentate is used to produce protein powder. The permeate is used to isolate lactose or is discarded. Such schemes, in contrast, are not economically viable for acid whey processing because of its lower protein content and issues relating to coagulation during powder formation steps. (G. Bylund, Dairy Processing Handbook, 2015, supra). As such, dairy producers resort to the more wasteful and environmentally unsustainable disposal methods mentioned above. Some acid whey utilization methods have been proposed in recent years, including enzymatic lactose extraction and anaerobic digestion. However, costly enzymatic catalysts limit the economic feasibility of lactose extraction. See B. Erickson, Chemical and Engineering News, 2017, 95, 26-30. Anaerobic digestion suffers from poor capacity and scalability. See New York Post (Jun. 14, 2013). Upstate plant turns toxic Greek yogurt byproduct into power. https://nypost.com/2013/06/14/upstate-plant-turns-toxic-greek-yogurt-byproduct-into-power/.

One potential use of acid whey is as a feedstock in the production of glucose/galactose syrups via enzymatic or acid-catalyzed lactose hydrolysis of the ultrafiltration permeate. Glucose/galactose syrup is a thick sugar solution consisting of roughly 20 wt % water, 68 wt % glucose and galactose, 11 wt % lactose, and 1 wt % minerals. R. a. T. R. de Boer, Netherlands Milk and Dairy Journal (Netherlands), 1981, 35, 95-111. It has three times the sweetness of lactose. The enzymatic approach to glucose/galactose syrup production is highly selective to the monosaccharides but is limited by prohibitive enzyme costs. N. Albayrak and S.-T. Yang, Enzyme and microbial technology, 2002, 31, 371-383. Acid hydrolysis, in contrast, is characterized by rapid catalytic turnovers (80% lactose hydrolysis in as little as 3 minutes) and lower catalyst costs. See the de Boer reference, supra, and V. a. M. L.-L. Gekas, Process Biochemistry, 1985, 2-12. However, undesired thermal and acid-catalyzed degradation reactions limit product yields.

Acid-catalyzed lactose hydrolysis has been studied using pure lactose solutions and whey ultrafiltrate solutions. Using pure lactose solutions, lactose hydrolysis was found to exhibit first order reaction kinetics with respect to the concentrations of the reactant and catalyst over both ion exchange resins and homogeneous mineral acids. However, non-ion exchange resin solid catalysts have not been studied for use in lactose hydrolysis, despite their use in other areas of food processing such as nickel catalysts used for hydrogenation in margarine production. See U.S. Pat. No. 3,949,105, issued Apr. 6, 1976, to Wieske et al. The kinetics of homogeneous acid-catalyzed lactose hydrolysis have been studied at temperatures below 100° C., with reported activation energies ranging from 98.5 to 154.4 kJ/mol. This variability between studies means that the kinetic parameters reported therein are not reliable for process design purposes. For that matter, none of these studies were carried out at the higher temperatures necessary for short retention times, nor did they include characterizations of degradation kinetics. Several studies have examined the kinetics of lactose hydrolysis using ultrafiltration whey permeates but, again, the majority were carried out at temperatures below 100° C., resulting in long reaction times comparable to enzymatic hydrolysis. de Boer et al. (supra) studied acid-catalyzed lactose hydrolysis using whey ultrafiltrate at 150° C., demonstrating 80% lactose hydrolysis in 3 minutes. Using demineralizing ion exchange resins and reverse osmosis as pre-hydrolysis filtration steps, they further demonstrated that a lower nitrogen content in the whey resulted in a less intense brown color after hydrolysis, though they did not report selectivities, yields, or concentrations of the monosaccharides produced. See J. R. a. T. A. N. Coughlin, Journal of Dairy Science, 1974, 58, 169-174; Heimlich and Martin, Journal of Pharmaceutical Sciences, 1960, 49, 592-597; Chen and Zall, Journal of Food Science, 1983, 48, 1741-1744; V. Hartofylax, C. Efstathiou and T. Hadjiioannou, Analytica chimica acta, 1989, 224, 159-168; R. MacBean, R. Hall and N. Willman, Aust. J. Dairy Technol, 1979, 34, 53; Demaimay and Printemps, Process Biochemistry, 1978; and S. Pain, Brief Communications, 1978, 948.

### SUMMARY

Disclosed herein is a method to convert aqueous, lactose-containing solutions in general, and whey wastes in particular, and acid whey more particularly still, into glucose/galactose syrups (that is, aqueous solutions comprising glucose and galactose). The method utilizes acid-catalyzed lactose hydrolysis to afford glucose and galactose monomers, while suppressing unwanted degradation reactions of the reactants and products at temperatures between about 120° C. and about 160° C. The reaction kinetics over solid acids and homogeneous mineral acid catalysts have been elucidated. The efficiency of the method (as expressed by reaction rates, product selectivities and yields) has been assessed for both pure lactose solutions and realistic acid whey feedstocks. A reaction kinetics model is proposed that describes the experimental data over the entire range of temperatures and reaction times considered. The reaction kinetics model was used to optimize the reaction conditions for lactose hydrolysis in water. Additional pretreatment steps are described that ultimately achieved an unprecedented 93% monosaccharide selectivity in acid whey. Reaction kinetics data for hydrolysis of lactose in real dairy waste streams was obtained. By providing an economically and scientifically feasible route to convert acid whey to glucose/galactose syrups, the method is highly useful because it reduces the water, energy, and carbon footprints of the US dairy industry. The method can be used to treat other dairy waste streams beyond acid whey, including milk waste and sweet whey.

Thus, disclosed herein is a method of making a solution containing glucose and galactose, the method comprising reducing the concentration of non-protein nitrogen-containing (NPN) compounds in a dairy by-product stream comprising lactose to yield a reduced-NPN dairy by-product stream. The reduced-NPN dairy by-product stream is then contacted with an acid catalyst at a temperature of from about 120° C. to about 200° C., and for a time of from about 1 minute to about 180 minutes. This results in at least a portion of the lactose contained in the reduced-NPN dairy by-product stream to be hydrolyzed into monosaccharides comprising glucose and galactose.

The concentration of NPN compounds in the dairy by-product stream may be reduced by any means now known or developed in the future, such as by contacting the dairy by-product stream with an effective amount of an adsorbent dimensioned and configured to adsorb NPN compounds. The adsorbent may, for example, comprise activated carbon. The adsorbent may be an ion exchange resin dimensioned and configured to adsorb NPN compounds. The adsorbent may alternatively comprise an adsorbent dimensioned and configured to adsorb urea.

The acid used in the method is preferably, but not required to be, a solid acid or a mineral acid. Preferred solid acids are acid-functionalized styrene-divinylbenzene copolymers (such as Amberlyst®-brand catalysts) and acid-functionalized tetrafluoroethylene-based fluoropolymer-copolymers (such as Nafion®-brand catalysts). Preferred mineral acids include, but are not limited to, boric acid (H₃BO₃), hydrobromic acid (HBr), hydrochloric acid (HCl), hydrofluoric acid (HF), hydroiodic acid (HI), nitric acid (HNO₃) perchloric acid (HClO₄), phosphoric acid (H₃PO₄), and sulfuric acid (H₂SO₄).

In another version of the method, the reduced-NPN dairy by-product stream is contacted with the acid catalyst at a temperature of from about 120° C. to about 180° C. This may be done for a time period of about 1 minute to about 90 minutes, or about 1 minute to about 45 minutes, or about 1 minute to about 10 minutes. Again, it is preferred but not required that the acid used is a solid acid or a mineral acid as described herein.

In another version of the method, the reduced-NPN dairy by-product stream is contacted with the acid catalyst at a temperature of from about 140° C. to about 180° C. This may be done for a time period of about 1 minute to about 90 minutes, or about 1 minute to about 45 minutes, or about 1 minute to about 10 minutes. Again, it is preferred but not required that the acid used is a solid acid or a mineral acid as described herein.

In yet another version of the method, the dairy by-product stream is ultrafiltered, nanofiltered, and/or filtered by reverse osmosis prior to reducing its NPN compound content. As noted previously, in this version of the method, the acid treatment step may be done for a time period of about 1 minute to about 90 minutes, or about 1 minute to about 45 minutes, or about 1 minute to about 10 minutes. Again, it is preferred but not required that the acid used is a solid acid or a mineral acid as described herein.

### BRIEF DESCRIPTION OF THE DRAWINGS

FIGS. 1A, 1B, and 1C are a series of graphs depicting concentration versus time data for lactose hydrolysis at 160° C., 150° C., 140° C., and 120° C. FIG. 1A presents lactose concentration. FIG. 1B presents total monosaccharide concentration. FIG. 1C presents 5-hydroxymethylfurfural (HMF) concentration. In FIGS. 1A and 1B, dashed lines represent model predictions. Reaction conditions: 0.115 M lactose in H₂O, 0.005 M H₂SO₄, stirring rate 400 RPM.

FIG. 2 is graph depicting model-predicted monosaccharide yields from acid-catalyzed lactose hydrolysis vs. temperature and reaction time. Reaction conditions: 0.11 M lactose in water; 0.005 M H₂SO₄.

FIGS. 3A, 3B, 3C, 3D are graphs depicting lactose conversion versus time for hydrolysis of lactose solutions using 0.005 M sulfuric acid (FIG. 3A), Amberlyst 70 (FIG. 3B), and zirconium phosphate (FIG. 3C) at constant temperature (150° C.). Monosaccharide selectivity versus time is shown on the secondary axis. FIG. 3D shows monosaccharide yield versus time for the experiments whose results are depicted in FIGS. 3A, 3B, and 3C. Connecting lines are visual aids. Reaction conditions: 3.8% lactose in water, 150° C., stir rate 400 RPM, acid concentration 5-47 mM.

FIG. 4 is a bar graph depicting the regenerability of Amberlyst 70-type catalysts for acid-catalyzed lactose hydrolysis in aqueous lactose solutions. The catalyst was recovered after each lactose hydrolysis reaction, regenerated with 0.1 M sulfuric acid, rinsed with deionized water, and dried overnight in a 110° C. oven. Error bars are 95% confidence intervals. Reaction conditions: 0.115 M lactose in H₂O, 0.01 M acid sites, stirring rate 450 RPM, lactose conversion held below 30%.

FIG. 5 is a flow chart for the production of glucose/galactose syrup from acid whey using acid-catalyzed lactose hydrolysis. This process can be done using homogeneous catalysts such as sulfuric acid or heterogeneous catalysts, such as solid acid catalysts. In the case of heterogeneous catalysts, the steps in blue (sulfuric acid addition, calcium hydroxide addition, and neutralization) are omitted. The green streams (whey protein concentrate, water, and glucose/galactose syrup) are products of the method.

### DETAILED DESCRIPTION

### Abbreviations and Definitions

The term “adsorbent” refers to any compound or composition capable of adsorbing non-protein nitrogen-containing (“NPN”) compounds from an aqueous solution. Adsorbents include, but are not limited to, activated carbon, silica gels, ion exchange resins, and zeolites. The term “adsorbent” also includes the urea adsorbents described in U.S. Pat. No. 4,677,135 issued Jul. 30, 1986 to Mishima, U.S. Pat. No. 4,715,961, issued Dec. 29, 1987 to Mishima, U.S. Pat. No. 4,721,652, issued Jan. 26, 1988, to Takai and Saitoh, and U.S. Publ. Pat. Appl. No. US 2015/0320922, published Nov. 12, 2015, to Malmborg and Meinander, all of which are incorporated herein by reference. The Mishima patents disclose a urea adsorbent comprising hollow microspheres each having an outer layer formed of a urea-permeable polymer and an inner layer formed of a polymer containing a polyoxyalkylene glycol derivative of the general formula —((CH₂)ₙ—O)ₘ—R, wherein R is hydrogen or a methyl group, “n” is an integer of 2-5, and “m” is an integer of at least 3. Takai and Saitoh disclose a composite comprising a core of urease-containing particles covered with fine zeolite powders for decomposing urea dissolved in a liquid and adsorbing the product resulting from the decomposition. The Malmborg and Meinander published application discloses a method of producing a copper-chitosan polymer material for adsorption of urea. A solid chitosan polymer material is immersed in a copper salt solution of a weak acid, such as copper acetateμ for allowing the copper ions to complex with the chitosan polymer. The macroporous chitosan polymer membrane has a thickness of no more than about 200 μm and has a pore size of between about 1 to 100 μm, for example 20 to 50 μm. Alternatively, solid chitosan fibers, solid chitosan particles or a chitosan gel bead can be complexed with copper acetate. The concentration of the copper acetate solution is above 50 mM whereby gel formation of the solid chitosan material is avoided during the complexation step.

The term “contacting” refers to the act of touching, making contact, or of bringing to immediate or close proximity, including at the molecular level, for example, to bring about a chemical reaction, or a physical change, e.g., in a solution or in a reaction mixture.

An “effective amount” refers to an amount of a chemical or reagent effective to facilitate a chemical reaction between two or more reaction components, and/or to bring about a recited effect. Thus, an “effective amount” generally means an amount that provides the desired effect.

The term “mineral acid” refers to inorganic compound that yield hydrogen ions and the conjugate base ions when dissolved in water. The term explicitly includes, but is not limited to, boric acid (H₃BO₃), hydrobromic acid (HBr), hydrochloric acid (HCl), hydrofluoric acid (HF), hydroiodic acid (HI), nitric acid (HNO₃), perchloric acid (HClO₄), phosphoric acid (H₃PO₄), and sulfuric acid (H₂SO₄).

Solid acid catalysts can comprise any solid material which displays acidic functionality. The solid acid catalyst can be used independently or alternatively can be utilized in combination with one or more mineral acid or other types of catalysts. Exemplary solid acid catalysts which can be utilized include, but are not limited to, heteropoly acids, acid resin-type catalysts, meso-porous silicas, acid clays, sulfated zirconia, molecular sieve materials, zeolites, and acidic material on a thermo-stable support. Where an acidic material is provided on a thermo-stable support, the thermo-stable support can include for example, one or more of silica, tin oxide, niobia, zirconia, titania, carbon, alpha-alumina, and the like. The oxides themselves (e.g., ZrO₂, SnO₂, TiO₂, etc.) which may optionally be doped with additional acid groups such as SO₄²⁻ may also be used as solid acid catalysts.

Further examples of suitable solid acid catalysts include strongly acidic ion exchangers such as cross-linked polystyrene containing sulfonic acid groups. For example, the Amberlyst®-brand resins are acid-functionalized styrene-divinylbenzene copolymers with different surface properties and porosities. The acidic functional group is generally of the sulphuric acid type. The Amberlyst®-brand resins are supplied as gellular or macro-reticular spherical beads. (Amberlyst® is a registered trademark of Rohm and Haas Company, Philadelphia, Pa.) Similarly, Nafion®-brand resins are acid-functionalized (typically sulfonated) tetrafluoroethylene-based fluoropolymer-copolymers which are solid acid catalysts. (Nafion® is a registered trademark of The Chemours Company FC, LLC, Wilmington, Del.)

Zeolites may also be used as solid acid catalysts. Of these, H-type zeolites are generally preferred, for example zeolites in the mordenite group or fine-pored zeolites such as zeolites X, Y and L, e.g., mordenite, erionite, chabazite, or faujasite. Also suitable are ultrastable zeolites in the faujasite group which have been dealuminated.

The acids used in the method may be Lewis acids. A Lewis acid is defined herein as any chemical species that is an electron-pair acceptor, i.e., any chemical species that is capable of receiving an electron pair, without limitation. (Conversely, a Lewis base is defined herein as any chemical species that is an electron-pair donor, that is, any chemical species that is capable of donating an electron pair, without limitation.)

In preferred versions of the invention, the Lewis acid (also referred to as the Lewis acid catalyst) may be any Lewis acid based on transition metals, lathanoid metals, and metals from Group 4, 5, 13, 14 and 15 of the periodic table of the elements, including boron, aluminum, gallium, indium, titanium, zirconium, tin, vanadium, arsenic, antimony, bismuth, lanthanum, dysprosium, and ytterbium. One skilled in the art will recognize that some elements are better suited in the practice of the method. Illustrative examples include AlCl₃, (alkyl)AlCl₂, (C₂H₅)₂AlCl, (C₂H₅)₃Al₂Cl₃, BF₃, SnCl₄ and TiCl₄.

The Group 4, 5 and 14 Lewis acids generally are designated by the formula MX₄; wherein M is Group 4, 5, or 14 metal, and X is a halogen independently selected from the group consisting of fluorine, chlorine, bromine, and iodine, preferably chlorine. X may also be a psuedohalogen. Non-limiting examples include titanium tetrachloride, titanium tetrabromide, vanadium tetrachloride, tin tetrachloride and zirconium tetrachloride. The Group 4, 5, or 14 Lewis acids may also contain more than one type of halogen. Non-limiting examples include titanium bromide trichloride, titanium dibromide dichloride, vanadium bromide trichloride, and tin chloride trifluoride.

Group 4, 5 and 14 Lewis acids useful in the method may also have the general formula MRₙX₄₋ₙ; wherein M is Group 4, 5, or 14 metal; wherein R is a monovalent hydrocarbon radical selected from the group consisting of C₁ to C₁₂ alkyl, aryl, arylalkyl, alkylaryl and cycloalkyl radicals; wherein n is an integer from 0 to 4; and wherein X is a halogen independently selected from the group consisting of fluorine, chlorine, bromine, and iodine, preferably chlorine. X may also be a psuedohalogen. Non-limiting examples include benzyltitanium trichloride, dibenzyltitanium dichloride, benzylzirconium trichloride, dibenzylzirconium dibromide, methyltitanium trichloride, dimethyltitanium difluoride, dimethyltin dichloride and phenylvanadium trichloride.

Group 4, 5 and 14 Lewis acids useful in method may also have the general formula M(RO)ₙR′ₘX₍ₘ₊ₙ₎; wherein M is Group 4, 5, or 14 metal; RO is a monovalent hydrocarboxy radical selected from the group consisting of C₁ to C₃₀ alkoxy, aryloxy, arylalkoxy, alkylaryloxy radicals; R′ is a monovalent hydrocarbon radical selected from the group consisting of C₁ to C₁₂ alkyl, aryl, arylalkyl, alkylaryl and cycloalkyl radicals; n is an integer from 0 to 4; m is an integer from 0 to 4 such that the sum of n and m is not more than 4; and X is a halogen independently selected from the group consisting of fluorine, chlorine, bromine, and iodine, preferably chlorine. X may also be a psuedohalogen. Non-limiting examples include methoxytitanium trichloride, n-butoxytitanium trichloride, di(isopropoxy)titanium dichloride, phenoxytitanium tribromide, phenylmethoxyzirconium trifluoride, methyl methoxytitanium dichloride, methyl methoxytin dichloride and benzyl isopropoxyvanadium dichloride.

Group 5 Lewis acids may also have the general formula MOX₃; wherein M is a Group 5 metal; X is a halogen independently selected from the group consisting of fluorine, chlorine, bromine, and iodine, preferably chlorine. A non-limiting example is vanadium oxytrichloride.

The Group 13 Lewis acids have the general formula MX₃; wherein M is a Group 13 metal and X is a halogen independently selected from the group consisting of fluorine, chlorine, bromine, and iodine, preferably chlorine. X may also be a psuedohalogen. Non-limiting examples include aluminum trichloride, boron trifluoride, gallium trichloride, indium trifluoride, and the like.

The Group 13 Lewis acids useful in method may also have the general formula: MRₙX₃₋ₙ wherein M is a Group 13 metal; R is a monovalent hydrocarbon radical selected from the group consisting of C₁ to C₁₂ alkyl, aryl, arylalkyl, alkylaryl and cycloalkyl radicals; and n is an number from 0 to 3; and X is a halogen independently selected from the group consisting of fluorine, chlorine, bromine, and iodine, preferably chlorine. X may also be a psuedohalogen. Non-limiting examples include ethylaluminum dichloride, methylaluminum dichloride, benzylaluminum dichloride, isobutylgallium dichloride, diethylaluminum chloride, dimethylaluminum chloride, ethylaluminum sesquichloride, methylaluminum sesquichloride, trimethylaluminum and triethylaluminum.

Group 13 Lewis acids useful in this disclosure may also have the general formula M(RO)ₙR′ₘX₃₍ₘ₊ₙ₎; wherein M is a Group 13 metal; RO is a monovalent hydrocarboxy radical selected from the group consisting of C₁ to C₃₀ alkoxy, aryloxy, arylalkoxy, alkylaryloxy radicals; R′ is a monovalent hydrocarbon radical selected from the group consisting of C₁ to C₁₂ alkyl, aryl, arylalkyl, alkylaryl and cycloalkyl radicals; n is a number from 0 to 3; m is an number from 0 to 3 such that the sum of n and m is not more than 3; and X is a halogen independently selected from the group consisting of fluorine, chlorine, bromine, and iodine, preferably chlorine. X may also be a psuedohalogen. Non-limiting examples include methoxyaluminum dichloride, ethoxyaluminum dichloride, 2,6-di-tert-butylphenoxyaluminum dichloride, methoxy methylaluminum chloride, 2,6-di-tert-butylphenoxy methylaluminum chloride, isopropoxygallium dichloride and phenoxy methylindium fluoride.

Group 13 Lewis acids useful in this disclosure may also have the general formula M(RC(O)O)ₙR′ₘX₃₋₍ₘ₊ₙ₎; wherein M is a Group 13 metal; RC(O)O is a monovalent hydrocarbacyl radical selected from the group consisting of C₂ to C₃₀ alkacyloxy, arylacyloxy, arylalkylacyloxy, alkylarylacyloxy radicals; R′ is a monovalent hydrocarbon radical selected from the group consisting of C₁ to C₁₂ alkyl, aryl, arylalkyl, alkylaryl and cycloalkyl radicals; n is a number from 0 to 3 and m is a number from 0 to 3 such that the sum of n and m is not more than 3; and X is a halogen independently selected from the group consisting of fluorine, chlorine, bromine, and iodine, preferably chlorine. X may also be a psuedohalogen. Non-limiting examples include acetoxyaluminum dichloride, benzoyloxyaluminum dibromide, benzoyloxygallium difluoride, methyl acetoxyaluminum chloride, and isopropoyloxyindium trichloride.

The most preferred Lewis acids for use in the method are metal halides generally and more specifically transition metal halides, lathanoid metal halides, and Group 5, 13, and 14 metal halides. Preferred among the metal halides are metal chlorides. Preferred transition metal chlorides include, but are not limited to, TiCl₄, VCl₃ and the like. Preferred Group 13 and 14 metal halides and chlorides include, but are not limited to, BF₃, AlCl₃, SnCl₄, InCl₃, and GaCl₃. Preferred lanthanoid chlorides include, but are not limited to, LaCl₃, DyCl₃ and YbCl₃.

Particularly preferred are the functionalized styrene-divinylbenzene copolymers, exemplified in the Examples by the various Amberlyst®-brand resins.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, from 1 to 9, from 3.6 to 4.6, from 3.5 to 9.9, and so forth.

All references to singular characteristics or limitations of the present invention shall include the corresponding plural characteristic or limitation, and vice-versa, unless otherwise specified or clearly implied to the contrary by the context in which the reference is made. That is, unless specifically stated to the contrary, “a” and “an” mean “one or more.” The phrase “one or more” is readily understood by one of skill in the art, particularly when read in context of its usage. For example, “one or more” substituents on a phenyl ring designates one to five substituents.

All combinations of method or process steps as used herein can be performed in any order, unless otherwise specified or clearly implied to the contrary by the context in which the referenced combination is made.

The methods of the present invention can comprise, consist of, or consist essentially of the essential elements and limitations of the method described herein, as well as any additional or optional ingredients, components, or limitations described herein or otherwise useful in synthetic organic chemistry.

Kinetics of Lactose Hydrolysis with Sulfuric Acid:

To elucidate the full reaction network underlying lactose hydrolysis, eight potential degradation pathways (both thermal and acid-catalyzed) were considered in addition to acid-catalyzed and thermal lactose hydrolysis as shown in Table 1. Because thermal degradation of a single sugar in water can be measured independently, the kinetics of thermal hydrolysis of lactose to afford glucose and galactose (k₈), and glucose and galactose thermal degradation to afford unquantifiable degradation products (k₉ and kio respectively) were quantified at temperatures ranging from 120° C. to 160° C., and apparent activation energies were estimated using Arrhenius analysis (see Table 3). (Menzinger and Wolfgang, Angewandte Chemie International Edition, 1969, 8, 438-444.) These thermal degradation pathways were then included in each of twelve alternative reaction kinetic models (shown in Table 2) which, in addition to acid-catalyzed lactose hydrolysis, tested for the presence of six possible acid-catalyzed degradation reactions: degradation of lactose, glucose and galactose (k₂, k₃ and k₄ respectively), as well as acid-catalyzed bimolecular degradation reactions (k₅, k₆, and k₇). Various combinations of Reactions 1 through 10 were fit to reaction kinetics data collected at 160° C. using a sulfuric acid catalyst as a calibration case to evaluate the relative predictive power afforded by each of the alternative models (see Table 2). Rates of all reactions were assumed to be first-order with respect to the concentration of reactants and acidic protons in solution. (J. F. Saeman, Industrial & Engineering Chemistry, 1945, 37, 43-52.)

TABLE 1
Summary of acid-catalyzed lactose hydrolysis reactions considered in the
kinetic model. The “H+” above the arrow in the reactions indicates an
acid-catalyzed step. Steps 2 through 9 are degradation reactions.

| Rate | |
|---|---|
| Con- | |
| stant | Reaction |
| k₁ | Acid-catalyzed lactose hydrolysis |
| | 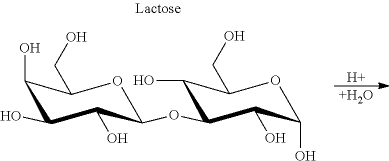 |
| | 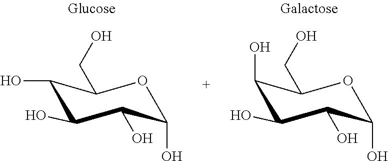 |
| k₂ | Acid-catalyzed lactose degradation |
| | 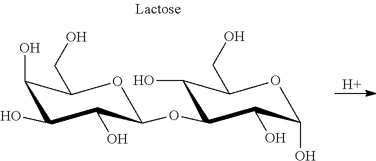 |
| | 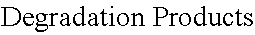 |
| k₃ | Acid-catalyzed glucose degradation |
| | 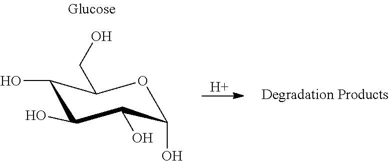 |
| k₄ | Acid-catalyzed galactose degradation |
| | 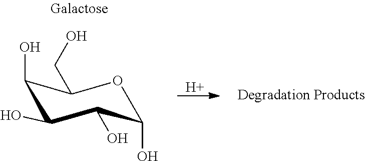 |
| k₅ | Acid-catalyzed bimolecular lactose + glucose degradation |
| | 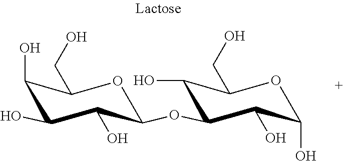 |
| | 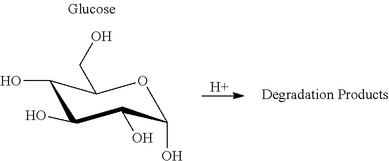 |
| k₆ | Acid-catalyzed bimolecular lactose + galactose degradation |
| | 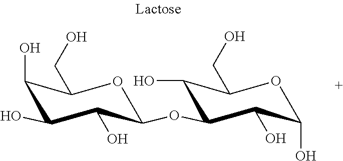 |
| | 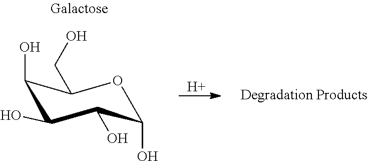 |
| k₇ | Acid-catalyzed bimolecular glucose + galactose degradation |
| | 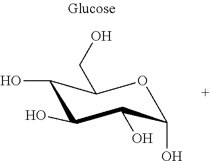 |
| | 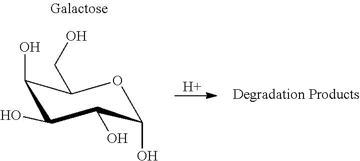 |
| k₈ | Thermal lactose hydrolysis |
| | 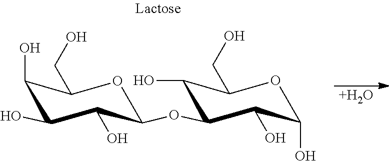 |
| | 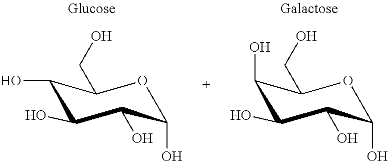 |
| k₉ | Thermal glucose degradation |
| | 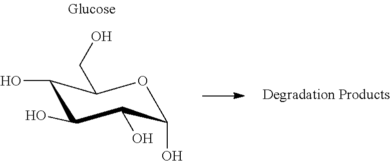 |
| k₁₀ | Thermal galactose degradation |
| | 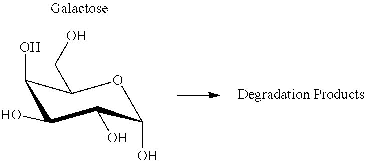 |

While additional parameters generally improve model fits to experimental data, the simplest model that can accurately predict system behavior is generally considered the most physically meaningful. (Posada and Buckley, Systematic biology, 2004, 53, 793-808.) Thus, as shown in Table 2, the relative efficacy of the twelve alternative models were evaluated using the Akaike Information Criterion (AIC), a statistical test which evaluates competing models based on their predictive ability, and their relative simplicity. (Id.) The AIC is calculated according to Equation 1 where k is the number of parameters being fitted, n is the total number of experimental data points, and RSS is the total residual sum of squares between the experimental and model-predicted values resulting from the data fit. To account for finite sample sizes, a correction factor is added to the AIC to produce a Corrected AIC, or AIC_{c} as shown in Equation 2.

$$\begin{matrix}AIC = 2 k - n ln ( \frac{RSS}{n} ) & ( 1 ) \\ {AIC}_{c} = AIC + \frac{2 k ( k + 1 )}{n - k - 1} & ( 2 )\end{matrix}$$

The model which returns the lowest AIC_{c} value is preferred because it represents the simplest model which accurately describes the experimental data. Table 2 presents the estimated values for the rate constants returned by each of the twelve alternative models (where again the rate constants for the three thermal degradation pathways were supplied as fixed, independently-measured quantities), along with the resulting RSS and the calculated AIC_{c} for each model.

The model which returns the smallest AIC_{c} is that which includes no acid-catalyzed degradation routes. It is possible that acid-catalyzed degradation reactions are occurring at these reaction conditions. However, as indicated by the analysis in Table 4, these reactions are sufficiently slow compared to acid-catalyzed lactose hydrolysis that they may be neglected for design purposes. Therefore, Model 12 best represents the base case for reaction kinetics modeling purposes: acid-catalyzed and thermal hydrolysis of lactose to afford glucose and galactose; and thermal reactions of the glucose and galactose to afford unaccountable degradation products.

TABLE 2
Fitted rate constants and AIC_{c} calculations for each of twelve alternative
reaction kinetics models. Confidence intervals are reported at the 95% confidence level.
The rate constants listed here refer to the reactions shown in Table 1. RSS is the residual
sum of squares of between experimental and model-predicted reaction kinetics data, k (no
subscript) is the number of parameters being fit in the model, and AICc is the corrected
Akaike Information Criterion value. Rate constants left blank indicate pathways that were
not included in that model. Rate constants k₁-k₄ are in units of M⁻¹ min⁻¹, k₅-k₇ are in units
of M⁻² min⁻¹. Reaction conditions: 160° C., each sugar present at 0.115M in H₂O, 0.005M
H₂SO₄ when no lactose present, 0.0005M H₂SO₄ when lactose present, stir rate 400
RPM.

| Mode | | | | | | | | RSS | | |
|---|---|---|---|---|---|---|---|---|---|---|
| 1 | k₁ | k₂ | k₃ | k₄ | k₅ | k₆ | k₇ | (×10⁶) | k | AIC_{c} |
| 1 | 70.0 ± 3.2 | −2.7 ± 6.2 | −0.2 ± 0.2 | 0.1 ± 0.3 | 44.8 ± 29.7 | 18.4 ± 29.7 | 0.7 ± 2.1 | 696 | 7 | 749 |
| 2 | 67.6 ± 2.8 | 4.8 ± 3.8 | −0.2 ± 0.2 | 0.1 ± 0.3 | | −5.0 ± 25.6 | 0.6 ± 2.2 | 740 | 6 | 741 |
| 3 | 69.0 ± 2.8 | 0.4 ± 3.8 | −0.2 ± 0.2 | 0.1 ± 0.3 | 35.1 ± 25.2 | | 0.6 ± 2.1 | 703 | 6 | 746 |
| 4 | 70.0 ± 3.2 | −2.6 ± 6.2 | −0.1 ± 0.1 | 0.2 ± 0.2 | 44.8 ± 29.6 | 17.8 ± 29.6 | | 698 | 6 | 747 |
| 5 | 67.7 ± 2.8 | 4.3 ± 2.6 | −0.1 ± 0.1 | 0.2 ± 0.2 | | | | 743 | 4 | 736 |
| 6 | 67.0 ± 2.6 | | −0.1 ± 0.1 | 0.2 ± 0.2 | | | | 799 | 3 | 727 |
| 7 | 67.8 ± 2.7 | 4.2 ± 2.6 | | 0.2 ± 0.2 | | | | 767 | 3 | 731 |
| 8 | 67.6 ± 2.7 | 4.5 ± 2.6 | −0.1 ± 0.1 | | | | | 766 | 3 | 731 |
| 9 | 67.7 ± 2.7 | 4.3 ± 2.6 | | | | | | 790 | 2 | 726 |
| 10 | 66.8 ± 2.6 | | −0.1 ± 0.1 | | | | | 827 | 2 | 721 |
| 11 | 67.1 ± 2.6 | | | 0.2 ± 0.2 | | | | 821 | 2 | 722 |
| 12 | 66.9 ± 2.7 | | | | | | | 849 | 1 | 716 |

Lactose hydrolysis experiments in the temperature range of 120° C. to 160° C. were conducted to determine the apparent activation energy of acid-catalyzed lactose hydrolysis. As mentioned above, the variable temperature data was analyzed using Model 12, which includes only lactose hydrolysis and thermal degradation reactions of the reactants and products. Maillard reactions that cause much of the degradations undergone by carbohydrates occur at higher, rather than lower temperatures. (D. S. Mottram, B. L. Wedzicha and A. T. Dodson, Nature, 2002, 419, 448-449.) Thus, reactions carried out at temperatures less than 160° C. are assumed to be accurately represented by the kinetic modeling scheme described by Model 12, which does not include acid-catalyzed degradation pathways.

Table 3 shows the apparent activation energies and pre-exponential factors associated with lactose hydrolysis (k₁ in Table 1) and the thermal degradation pathways of lactose, glucose, and galactose (k₈, k₉, and kio in Table 1, respectively). The apparent activation energy was determined to be 135.5 kJ/mol. This value is in agreement with MacBean et al. (R. MacBean, R. Hall and N. Willman, Aust. J. Dairy Technol, 1979, 34, 53) and Coughlin et al. (J. R. a. T. A. N. Coughlin, Journal of Dairy Science, 1974, 58, 169-174) who obtained apparent activation energies of 132 kJ/mol and 125 kJ/mol respectively, although their reaction temperatures were below 100° C. The activation energies for glucose and galactose degradation are 106.3 and 116.6 kJ/mol respectively which conflicts with Mosier et al. who report an activation energy of 72.6 kJ/mol for thermal glucose degradation in a similar temperature range. (N. S. Mosier, C. M. Ladisch and M. R. Ladisch, Biotechnology and bioengineering, 2002, 79, 610-618.)

TABLE 3
Estimated kinetic parameters associated with lactose
hydrolysis and thermal degradation reactions of lactose,
glucose, and galactose.

| Rate Constant | log₁₀ [A/s⁻¹] | E_{A} (kJ/mol) |
|---|---|---|
| k₁ | 16.39 ± 0.02 | 135.5 ± 3.9 |
| k₈ | 15.27 ± 0.75 | 156.3 ± 20.1 |
| k₉ | 8.40 ± 0.76 | 106.3 ± 20.7 |
| k₁₀ | 9.73 ± 0.44 | 116.6 ± 9.8 |

Kinetic parameters fit experimental data at T = 120° C. to 160° C. [H⁺] = 0.5-5 mM. 95% confidence interval used. All reactions are first order with respect to feed composition.

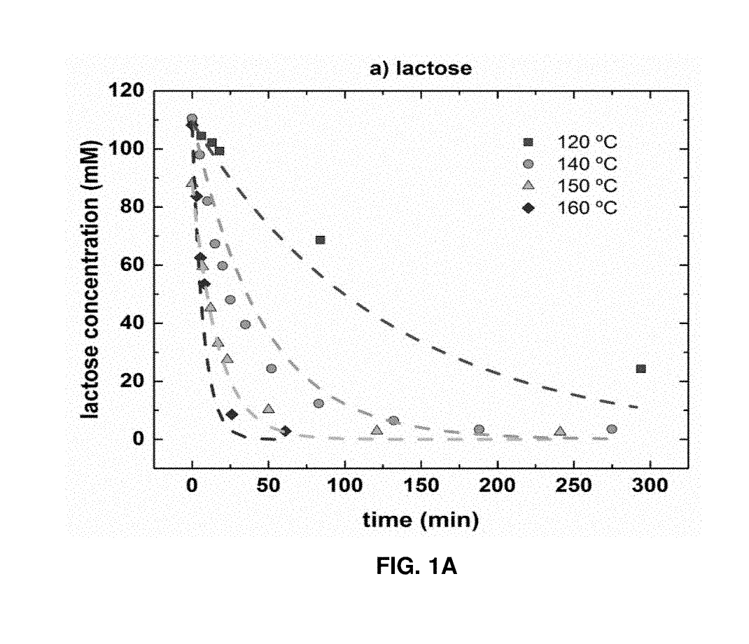

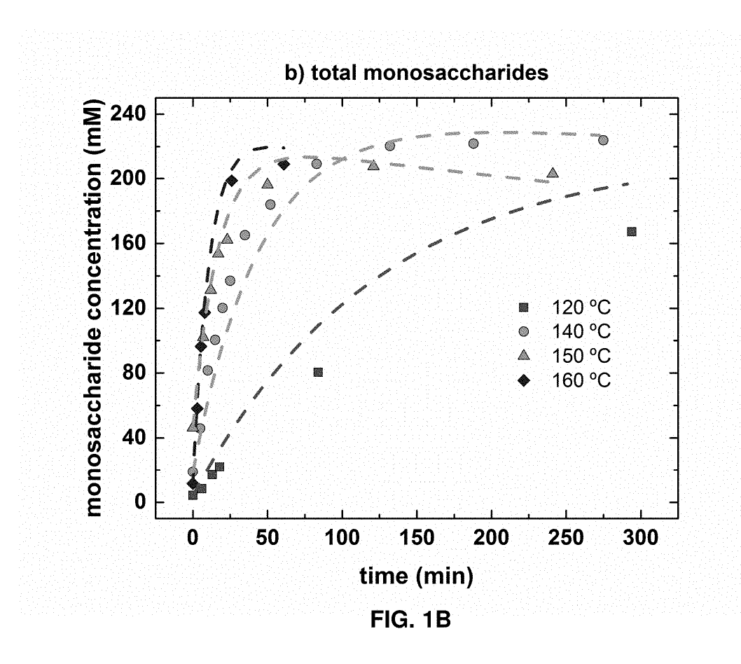

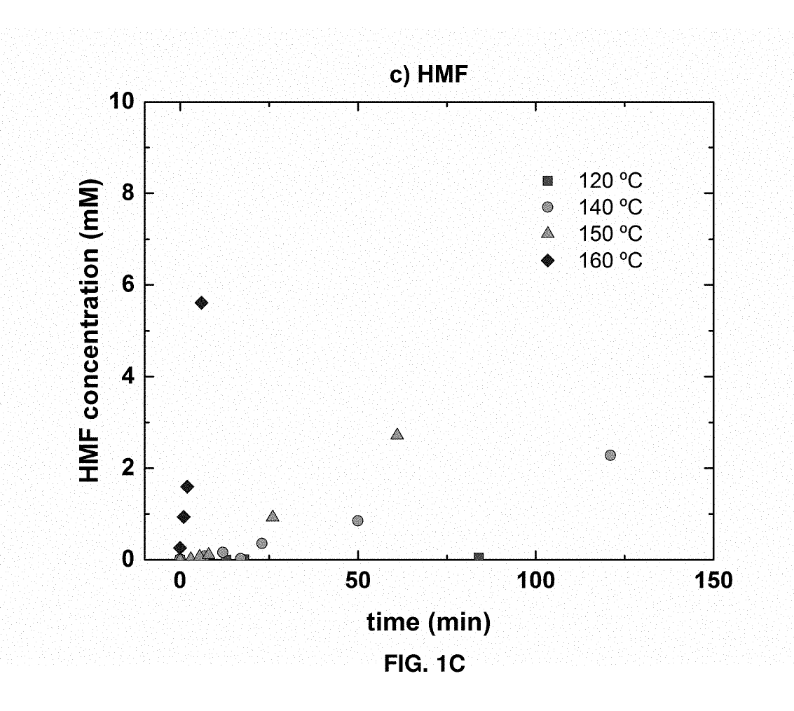

FIGS. 1A, 1B, and 1C show the experimental and model-predicted time courses for lactose hydrolysis over dilute sulfuric acid at temperatures from 120° C. to 160° C. In all cases, the model predicts the data well, although the model sometimes over predicts the monosaccharide concentration at high lactose conversion due to the omission of degradation routes in the model. FIG. 1A shows the concentration of lactose versus time (reactant; decreasing). FIG. 1B shows the concentration of total monosaccharides versus time (product; increasing). FIG. 1C shows the concentration of 5-hydroxymethylfurfural (HMF) versus time (degradation product; increasing). HMF is found in many heat-treated foods rich in carbohydrates in concentrations up to 3500 ppm. S. Kus, F. Gogus and S. Eren, International Journal of Food Properties, 2005, 8, 367-375. 3500 ppm HMF corresponds roughly to about 190 mM HMF at the carbohydrate loadings used in FIGS. 1A, 1B, and 1C. HMF has not been found to have toxic or carcinogenic affects at this concentration. (K. Abraham, R. Gürtler, K. Berg, G. Heinemeyer, A. Lampen and K. E. Appel, Molecular nutrition & food research, 2011, 55, 667-678.) The maximum HMF concentration increases with temperature, ranging from negligible at 120° C. to 5.9 mM at 160° C.

The estimated kinetic parameters from Table 3 were incorporated into a model-predictive framework by defining rate expressions in the form of Equations 1 through 4 in a MATLAB®-brand software-based simulation environment (The MathWorks, Inc., Natick, Mass., USA). In Equations 1 through 4, rates (rᵢ) 1, 8, 9 and 10 represent the rate of acid-catalyzed lactose hydrolysis, thermal (non-acid-catalyzed) lactose hydrolysis, thermal glucose degradation, and thermal galactose degradation, respectively where R is the gas constant, T is the temperature, Cᵢ is the molar concentration of the i^{th} species, Aᵢ, and Eᵢ, are the pre-exponential factor and apparent activation energy for the i^{th} reaction, respectively.

$$\begin{matrix}{r}_{1} = {A}_{1} exp ( - \frac{{E}_{a 1}}{RT} ) {C}_{lactose} {C}_{{H}^{+}} & ( 3 ) \\ {r}_{8} = {A}_{8} exp ( - \frac{{E}_{a 8}}{RT} ) {C}_{lactose} & ( 4 ) \\ {r}_{9} = {A}_{9} exp ( - \frac{{E}_{a 9}}{RT} ) {C}_{glucose} & ( 5 ) \\ {r}_{10} = {A}_{10} exp ( - \frac{{E}_{a 10}}{RT} ) {C}_{galactose} & ( 6 )\end{matrix}$$

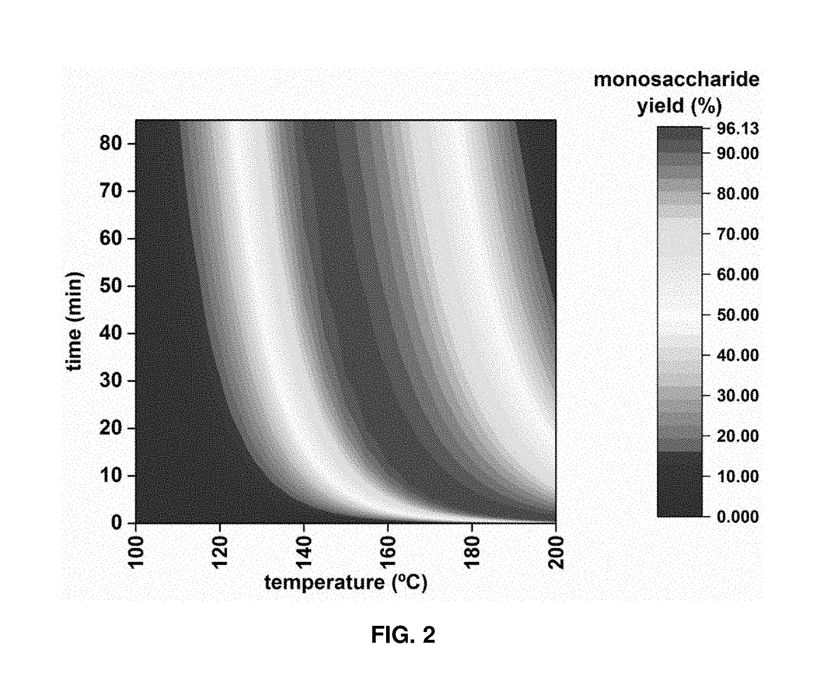

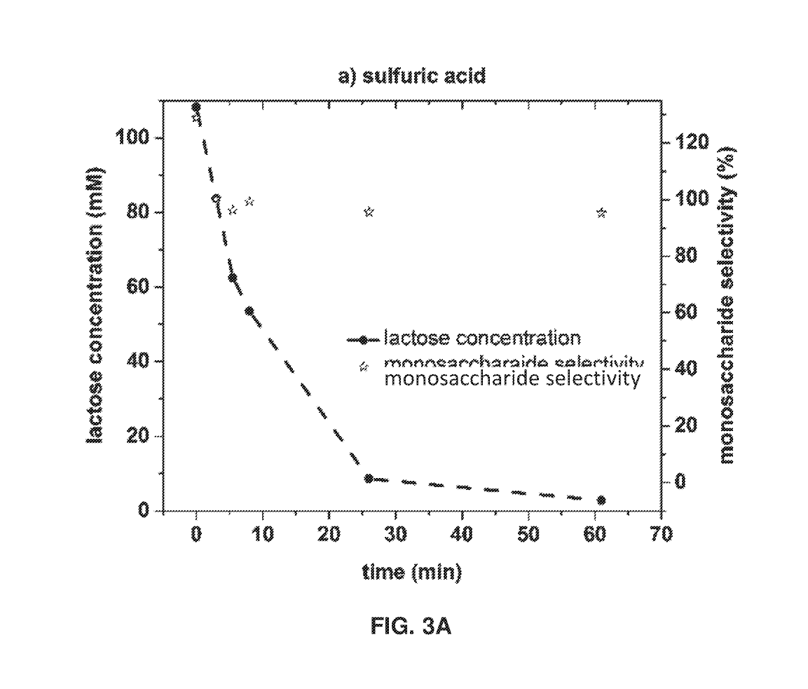

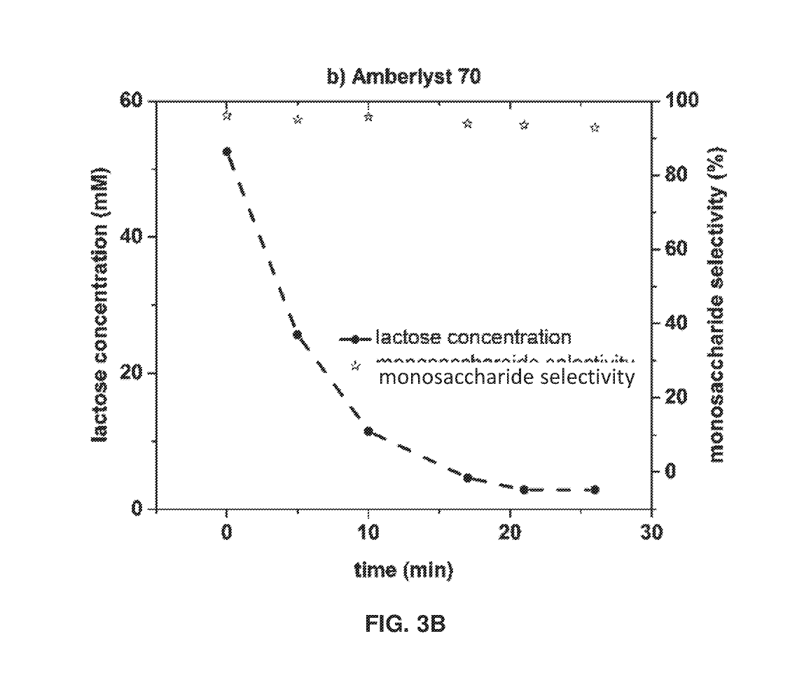

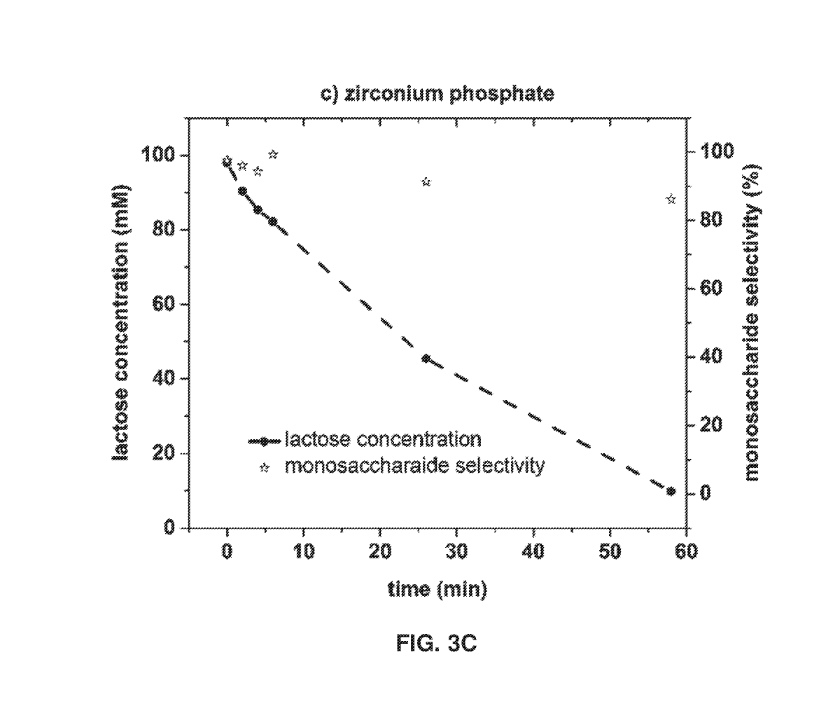

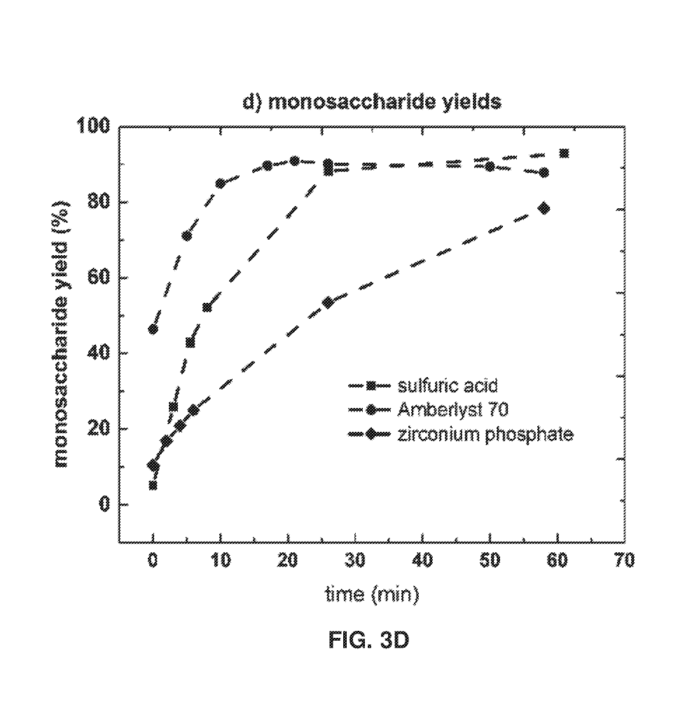

Model-predicted reaction time courses for acid-catalyzed lactose hydrolysis over 5 mM sulfuric acid are presented in FIG. 2. These results indicate that a maximum monosaccharide yield of ˜96% is achievable in less than 10 minutes at temperatures above 180° C. At temperatures above 160° C., however, yields of desired products are maximized within a relatively narrow range of reaction times. In contrast, a reaction temperature of 140-160° C. affords a monosaccharide yield of >95% over a wide range of reaction times (30-70 minutes). As such, product yields within this temperature range would be relatively insensitive to disturbances in process conditions, which is desirable from a design perspective. Furthermore, as indicated in FIGS. 3A, 3B, and 3C (see below), the reaction is nearly 100% selective to desired products (monosaccharides) at all reaction times below 160° C. Accordingly, toward the design of scalable process for use in processing actual dairy waste streams, reaction performance was tested using lactose solutions over solid acid catalysts, and realistic acid whey feedstocks over a sulfuric acid catalyst at a fixed reaction temperature of 150° C.

Hydrolysis of Lactose with Solid Acid Catalysts:

Sulfuric acid, as well as the solid acid catalysts Amberlyst® 70 (Rohm and Haas Company, Philadelphia, Pa., a wholly owned subsidiary of DowDuPont Inc., Midland, Mich. and Wilmington, Del.) and zirconium phosphate, were studied as catalysts for lactose hydrolysis in aqueous lactose solutions at 150° C. Lactose hydrolysis reactivity with both solid and mineral acid catalysts fits a first order model with respect to reactants and catalyst, as was reported in H. C. Chen and R. R. Zall, Journal of Food Science, 1983, 48, 1741-1744. FIG. 3A shows the lactose concentration and monosaccharide selectivity as a function of time at 150° C. for lactose hydrolysis over sulfuric acid. FIG. 3B shows the lactose concentration and monosaccharide selectivity as a function of time at 150° C. for lactose hydrolysis over Amberlyst® 70-brand solid acid catalyst. FIG. 3C shows the lactose concentration and monosaccharide selectivity as a function of time at 150° C. for lactose hydrolysis over zirconium phosphate. Unlike sulfuric acid, adding more Amberlyst® 70-brand catalyst does not decrease the pH of the solution at temperatures below 190° C. Thus, more solid acid catalyst can be added without concerns about an acidic environment damaging process equipment. As such, the acid site concentration was set at 47 mM for the Amberlyst® 70 case compared to 5 mM for sulfuric acid. When 5 mM sulfuric acid is the catalyst, the lactose concentration decreases from 108 mM to 9 mM in 26 minutes with a monosaccharide selectivity above 96%. See FIG. 3A. Using Amberlyst® 70 solid acid as the catalyst, the lactose concentration decreases from 53 mM to 5 mM in 17 minutes with a monosaccharide selectivity above 94%. See FIG. 3B. The difference between initial lactose concentrations for the sulfuric acid and Amberlyst® 70 cases exists because about half of the lactose was hydrolyzed in the Amberlyst® 70 reaction by the time that the temperature reached 150° C., whereas less than 10% of the lactose reacted prior to reaching temperature for the sulfuric acid reaction. With zirconium phosphate as the catalyst, the monosaccharide selectivity decreased to 86% at 91% lactose conversion.

FIG. 3D shows the monosaccharide yield over time for each of the three catalysts tested. Sulfuric acid and Amberlyst® 70 solid acid catalyst produce similar monosaccharide yields, although the solid acid catalyst reaches its maximum yield of 91% within 20 minutes compared to 60 minutes for sulfuric acid to reach 93%. Zirconium phosphate did not reach 80% monosaccharide yield after nearly an hour of reaction time.

Table 4 shows the measured rate constant, monosaccharide selectivity, and HMF selectivity for lactose hydrolysis at 150° C. with sulfuric acid, Amberlyst® 70 solid acid and zirconium phosphate catalysts. The rate constant for hydrolysis reactions catalyzed by Amberlyst® 70 is 0.057 s⁻¹M⁻¹, only 18% the rate constant for hydrolysis with sulfuric acid. However, the monosaccharide selectivity for Amberlyst® 70 and sulfuric acid are similar (94% for Amberlyst® 70 and 96% for sulfuric acid), as are the concentrations of HMF and unidentified carbon (4.9% and 1.2% for Amberlyst® 70 compared to 4.0% and 0.4% for sulfuric acid). Zirconium phosphate, however, produces more than double the amount of degradation products, resulting in HMF and undetected carbon selectivities of 4.9% and 8.8% respectively. See Table 4.

TABLE 4
Effect of different acids on the rate of lactose hydrolysis and the
selectivities to different products. Reaction conditions: 3.8%
lactose in water with temperature of 150° C., stir rate 400 RPM.

| | | Lactose | Mono- | | Unidentified |
|---|---|---|---|---|---|
| | | Con- | saccharide | HMF | Carbon |
| | k₁ | version | Selectivity | Selectivity | selectivity |
| Catalyst | (s⁻¹M⁻¹) | (%) | (%) | (%) | (%) |
| Sulfuric | 0.324 | 92 | 96 | 0.4 | 4.0 |
| acid^{a} | | | | | |
| Amberlyst | 0.057 | 95 | 94 | 1.2 | 4.9 |
| 70^{b} | | | | | |
| Zirconium | 0.081 | 91 | 86 | 5.1 | 8.8 |
| phosphate^{a} | | | | | |

^{a}Data point at 26 minutes.
^{b}data point at 17 minutes.

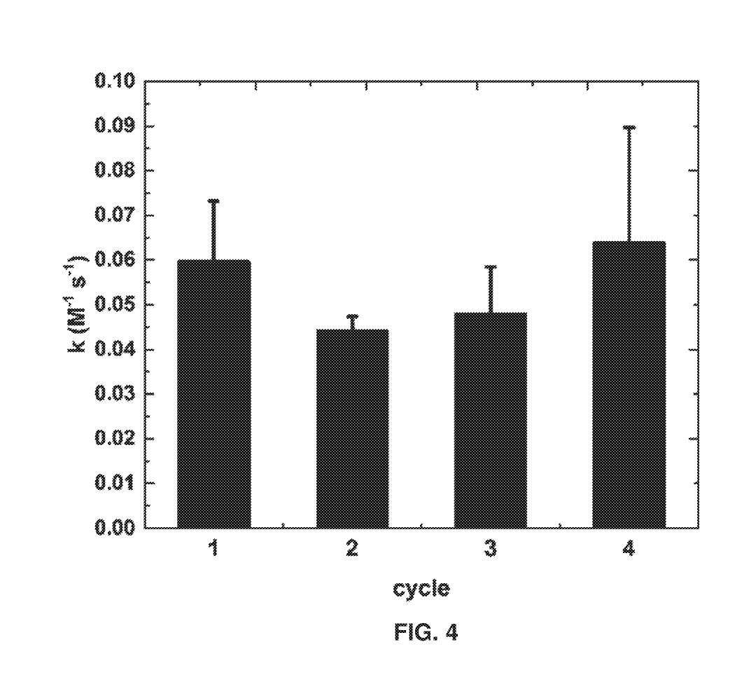

FIG. 4 presents the measured rate constant of lactose hydrolysis in aqueous solutions for recycling an Amberlyst® 70 catalyst at less than 30% conversion. After each experiment, the catalyst was recovered, regenerated with 0.1 M sulfuric acid, rinsed with water, and dried overnight. As evidenced by FIG. 4, the rate constant for acid-catalyzed lactose hydrolysis remained unchanged (within error) between each experiment, demonstrating that the catalyst is regenerable under these conditions.

### Characterization of Acid Whey and Acid Whey Permeates:

Table 5 shows the composition of untreated acid whey and acid whey subjected to various pre-treatment filtration steps. Untreated acid whey is 93.91 wt % water and 6.09% solids with 3.8 wt % lactose, 0.104 wt % protein, 0.12 wt % fat, and 0.75 wt % ash. This characterization is consistent with other reported analyses of acid whey. See Bylund, Dairy Processing Handbook, 1995, supra. Ultrafiltration (UF) effectively removes all of the protein and fat from the untreated acid whey but only 10% of the non-protein nitrogen (NPN). UF reduces the solids (chemical species left after evaporation for four hours at 100° C.) concentration from 6.09 wt % to 5.40 wt % but does not change the concentrations of ash (minerals such as calcium and sodium) or lactose. Nanofiltration (NF) reduces the NPN concentration by only 0.003 wt %, indicating that most molecules that comprise NPN are too small to be filtered. Adsorbants such as activated carbon (AC) have been shown to adsorb urea (W.-K. Cheah, Y.-L. Sim and F.-Y. Yeoh, Materials Chemistry and Physics, 2016, 175, 151-157) and other nitrogen-containing species. R. a. T. R. de Boer, Netherlands Milk and Dairy Journal (Netherlands), 1981, 35, 95-111. Filtering the UF permeate with AC reduces the NPN concentration by 33% down to 0.034 wt %. NF reduces the solids and lactose concentrations of UF permeate by 22% and 13% respectively.

TABLE 5
Effect of filtration method on the composition of acid whey.

| | Protein | NPN | Solids | Ash | Fat | Lactose |
|---|---|---|---|---|---|---|
| Feedstock | (wt %) | (wt %) | (wt %) | (wt %) | (wt %) | (wt %) |
| Untreated acid | 0.104 | 0.058 | 6.09 | 0.75 | 0.12 | 3.8 |
| whey | | | | | | |
| UF acid whey | 0 | 0.051 | 5.40 | 0.75 | <0.01 | 3.8 |
| permeate | | | | | | |
| NF acid whey | 0 | 0.048 | 4.20 | 0.66 | <0.01 | 3.3 |
| permeate | | | | | | |
| AC UF acid | 0 | 0.034 | 3.84 | 0.72 | .03 | 2.5 |
| whey permeate | | | | | | |

### Hydrolysis Reactions of Acid Whey and Acid Whey Permeates:

Table 6 shows the result of lactose hydrolysis reactions at 150° C. with a 5 mM sulfuric acid catalyst with both aqueous lactose solutions and acid whey feedstocks. The rate constant for lactose hydrolysis in aqueous lactose solutions is 0.324 s⁻¹M⁻¹ with a monosaccharide selectivity of 96%. Urea was added to aqueous lactose solutions at 0.17 wt % and 0.58 wt % to study the effect of non-protein nitrogen (NPN) on lactose hydrolysis. These concentrations of urea represent the concentration of NPN in acid whey (see Table 5) and 30% of the NPN concentration in acid whey. Hydrolysis of these urea-doped solutions resulted in a decrease in the rate of hydrolysis of 56% and 94% respectively. The monosaccharide selectivity decreased from 96% in pure lactose solutions to 91% and 72%, and the undetected carbon selectivity increased from 4.0% to 8.3% and 24.8% respectively. This decrease in rate and monosaccharide selectivity upon the addition of urea, a major component of NPN, indicates that NPN has a deleterious effect on acid-catalyzed lactose hydrolysis.

Lactose hydrolysis experiments on untreated acid whey have a rate constant of 0.13 s⁻¹M⁻¹ with a monosaccharide selectivity of 90%. UF increases the rate constant by 23% but does not increase the monosaccharide selectivity. Further filtering the UF acid whey permeate with NF or AC produces the highest monosaccharide selectivities and yields. NF acid whey permeate had the highest rate constant, 0.18 s⁻¹M⁻¹ with a monosaccharide selectivity of 92%, while AC pretreatment produced a monosaccharide selectivity of 93%. The AC-treated UF acid whey permeate produced a lactose conversion higher than that of NF acid whey permeate despite an 18% lower rate due to the lower initial lactose concentration. The HMF selectivity was lower after filtration in all cases, reaching a low of 3.1% for the NF acid whey permeate. The unidentified carbon selectivity was the lowest for the UF acid whey permeate treated with AC, most likely because the AC removed much of the NPN which contributes to side reactions producing unidentified carbon. However, treating the UF acid whey permeate with NF or AC decreases the lactose concentration by 13% and 34% respectively (see Table 5), causing the monosaccharide yield from the raw feedstock to drop to 74% and 56% respectively. From this, it is clear that there exists a tradeoff between the purity of the hydrolyzed acid whey stream and the monosaccharide yield. Because UF produces the highest monosaccharide yield from acid whey, it appears to be the most cost-effective option for industrial purposes. However, if higher purity products are required, a filtration strategy such as NF may be the best option due to its improved monosaccharide selectivity despite the decrease in monosaccharide yield from feedstock.

TABLE 6
Hydrolysis of lactose and acid whey streams with sulfuric acid. Reaction
conditions: temperature 150° C., pH 2.3, H₂SO₄, stir rate 400 RPM. In experiments
with added urea, the quantity of urea added was determined as a percentage of the
NPN content in acid whey.

| | | | | | | Mono- | |
|---|---|---|---|---|---|---|---|
| | | | | | | saccharide | |
| | | | | Mono- | | Yield | Unidentified |
| | | Lactose | Reaction | saccharide | HMF | from | Carbon |
| Lactose | k₁ | Conversion | Time | Selectivity | Selectivity | Feedstock | Selectivity |
| Source | (s⁻¹M⁻¹) | (%) | (min) | (%) | (%) | (%) | (%) |
| Lactose | 0.32 | 92 | 26 | 96 | 0.4 | 88 | 4.0 |
| solution | | | | | | | |
| Lactose | 0.14 | 81 | 30 | 91 | 0.6 | 74 | 8.3 |
| solution | | | | | | | |
| with | | | | | | | |
| 0.17 wt | | | | | | | |
| % urea | | | | | | | |
| Lactose | 0.02 | 28 | 30 | 72 | 2.6 | 21 | 24.8 |
| solution | | | | | | | |
| with | | | | | | | |
| 0.58 wt | | | | | | | |
| % urea | | | | | | | |
| Untreated | 0.13 | 88 | 58 | 90 | 5.1 | 79 | 4.5 |
| acid whey | | | | | | | |
| UF acid | 0.16 | 89 | 58 | 90 | 4.7 | 80 | 5.1 |
| whey | | | | | | | |
| permeate | | | | | | | |
| NF acid | 0.18 | 91 | 58 | 92 | 3.1 | 74 | 5.3 |
| whey | | | | | | | |
| permeate | | | | | | | |
| AC UF | 0.15 | 93 | 58 | 93 | 4.3 | 56 | 3.1 |
| acid | | | | | | | |
| whey | | | | | | | |
| permeate | | | | | | | |

### Acid-Catalyzed Lactose Hydrolysis Process Using Acid Whey:

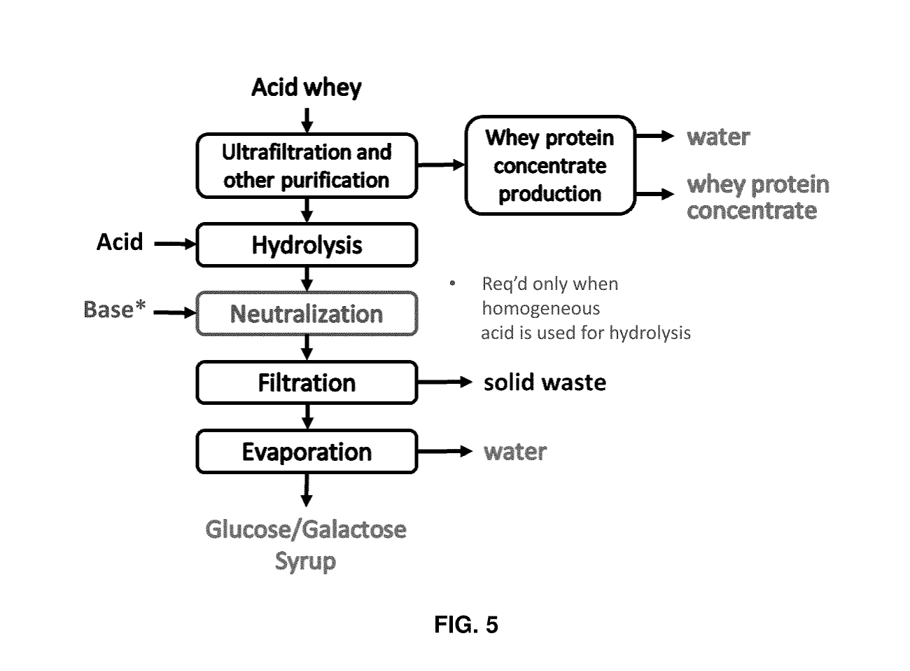

FIG. 5 shows a block flow diagram for conversion of acid whey into glucose/galactose syrup and whey protein concentrate (WPC). The acid whey first undergoes UF. The UF retentate is sent to a standard industrial WPC process. (See Bylund, Dairy Processing Handbook, 1995, supra.) The UF permeate may undergo further filtration, such as NF or AC adsorption, before entering the hydrolysis reactor with either homogeneous or heterogeneous acid catalysts. If homogeneous acid catalysts such as sulfuric acid, are used there must be a neutralization step after the hydrolysis reactor where calcium hydroxide or some other neutralizing agent is added. For the heterogeneous acid catalysis case, the catalyst will be contained in the hydrolysis reactor, negating the need for a neutralization step. After filtration, the hydrolyzed lactose stream is evaporated to roughly 18 wt % water to produce the final glucose/galactose syrup product.

The method dovetails nicely with the commercial production of Greek yogurt, which produces as a by-product copious amounts of acid whey. Thus, when the present method is incorporated into a yogurt production line, three additional products are formed: WPC, water, and glucose/galactose syrup. The WPC could be either added to other dairy products to increase the protein content or sold to the existing 20 million ton per year (2018) market at a price of $1,760 (2018) per ton for use as a dietary supplement or a food additive. See, for example, Mordor Intelligence. Whey Protein Market-Growth, Trends And Forecast (2017-2022), https://www.mordorintelligence.com/industry-reports/global-whey-protein-market-industry, (accessed Dec. 7, 2017) and USDA—Agricultural Marketing Service (AMS). Central & West Dry WPC 34% Monthly Average Mostly Prices, https://www.ams.usda.gov/mnreports/dymawpc.pdf, (accessed Sep. 22, 2017).

The water is produced during evaporation of the hydrolyzed lactose stream and the whey protein stream. This water can be used elsewhere in the dairy plant, either for process water or added in other food products. The glucose/galactose syrup can be used as a sweetener for sweet dairy products such as ice cream, yogurt, and chocolate milk or sold. It is useful as a replacement for high-fructose corn syrup or other sweeteners.

The effects of catalyst and filtration methods on the rate of acid-catalyzed lactose hydrolysis, and the selectivity of this reaction to monosaccharides (glucose and galactose) in aqueous lactose solutions and realistic acid whey feedstocks were studied. Acid-catalyzed lactose hydrolysis in untreated acid whey has a monosaccharide selectivity of 90% at a pH of 2.3 after a one hour reaction time at 150° C. The protein, non-protein nitrogen, and other contaminants in the acid whey cause unwanted side reactions and decrease the selectivity to desired products. Ultrafiltration removes the protein and fat from acid whey without removing lactose, resulting in a 23% higher reaction rate and 8% lower 5-hydroxymethylfurfural (HMF) selectivity, but does not increase the monosaccharide selectivity from untreated acid whey. Further treatment of the ultrafiltered acid whey permeate with nanofiltration increases the rate of hydrolysis by an additional 13% and decreases the HMF selectivity by 34%. Nanofiltration and activated carbon pretreatment both improve the purity of the hydrolyzed acid whey by increasing the monosaccharide selectivity to 92% and 93% respectively. However, they also remove 13% and 34% of the lactose in the ultrafiltered acid whey permeate, resulting in monosaccharide yields from the feedstock of 74% and 56% respectively compared to 80% for ultrafiltration acid whey permeate. Both mineral acid catalysts and the solid acid catalyst Amberlyst 70 produce monosaccharide selectivities above 94% at conversions above 90% when lactose is hydrolyzed in pure water at 150° C. Finally, we used statistical analysis to elucidate a reaction network for acid-catalyzed lactose hydrolysis including thermal hydrolysis of lactose and thermal degradation pathways for glucose and galactose. While acid-catalyzed degradation pathways likely exist, the inclusion of those pathways did not significantly improve the predictive ability of the reaction kinetics model developed in this study, meaning that these reaction pathways may be neglected for design purposes within the temperature range and reaction times explored. These results show that acid whey has the potential to be effectively recycled to produce food additives instead of being disposed of in economically and environmentally unsustainable ways, which is the current practice

### Examples

The following examples are included herein solely to provide a more complete description of the method disclosed and claimed herein. The examples do not limit the scope of the claims in any fashion.

### HPLC Analysis:

Product quantification was performed by High Performance Liquid Chromatography (HPLC). Urea quantification was done using a Waters HPLC (Waters Corporation, Milford, Mass.) with an Aminex®-brand HPX-87P lead column (Bio-Rad Inc., Hercules, Calif.) at 85° C. and a mobile phase of 0.6 mL/min of pH 7 water. The photo-diode array (UV) at 190 nm was used for urea quantification. All other species were quantified using a Shimadzu HPLC (Shimadzu Corporation, Columbia, Md.) with Aminex® HPX-87H acid column at 30° C. with mobile phase of 0.6 mL/min of 5 mM sulfuric acid. Samples were filtered using a 0.2 micrometer membrane (VMR brand) and diluted to 10% of the original concentration with distilled water before injection in the HPLC. HMF was quantified at 290 nm using the UV, and all other compounds were quantified using the refractive index detector (RI).

### Hydrolysis and Degradation Reactions:

Aqueous lactose solutions were prepared by adding lactose and sulfuric acid to deionized water to reach 3.8 wt % lactose and 5 mM sulfuric acid. For degradation studies, glucose or galactose was used or was added to lactose to reach a final concentration corresponding to the same concentration as 3.8 wt % lactose. Acidified acid whey was prepared by adding sulfuric acid until the pH reached 2.3, the same pH as 5 mM sulfuric acid in water. 4 mL or 2 mL of lactose solution or acid whey, respectively, was place with a stir bar in 10 mL glass vials. The glass vials were capped and placed in a silicone oil bath that was being held at the appropriate temperature and stirred at no less than 400 RPM. After removal from the oil bath, the vials were cooled in air briefly before being quenched in an ice bath. For lactose hydrolysis experiments using solid acid catalysts, an equal mass of catalyst was loaded into each reactor vial along with the 3.8 wt % lactose solution. The acid site concentration in the reactor vial was then calculated using acid site concentrations from the literature or manufacturer specifications (2.55 mmol g⁻¹ for Amberlyst® 70 (manufacturer's specification) and 1.362 mmol g⁻¹ for zirconium phosphate). To regenerate the Amberlyst® 70, 5 mL of 0.1 M sulfuric acid were added to the roughly 0.5 g of Amberlyst® 70 and stirred at 100 RPM for one minute. This was done twice, followed by 5 rinses of 20 mL of DI water stirred at 100 RPM for one minute each rinse. The Amberlyst® 70 was then dried overnight in a 110° C. oven prior to use in subsequent experiments.

### Rate Determination:

Reaction kinetics analysis was performed using MATLAB (Version R2016b) software. A set of ordinary differential equations (ODEs) containing experimental sugar concentration versus time data was input to the MATLAB script. The ODEs were solved using the differential equation solver function “ode23t,” with the optimization function “nlinfit” (Levenberg-Marquette non-linear least-squares algorithm) being used to minimize the error between model-predicted and the experimental reaction kinetics data.

### Acid Whey Characterization:

Ash, fat, and solids quantification of acid whey and acid whey permeates was performed by RTech laboratories (St. Paul, Minn.). Total nitrogen composition was determined by performing Kjeldahl analysis on acid whey, ultrafiltration (UF) permeate, and nanofiltration (NF) permeate. To determine protein and non-protein nitrogen (NPN) composition, 10 wt % trichloroacetic acid was added to the acid whey samples and stirred at room temperature for an hour. The acid whey was subsequently centrifuged at 5000 RPM and the protein-rich pellet (if present) was discarded. Kjeldahl analysis was performed on the supernatant to determine NPN composition, the NPN composition was subtracted from total nitrogen, and protein composition was calculated using the dairy protein factor of 6.38. R. a. T. R. de Boer, Netherlands Milk and Dairy Journal (Netherlands), 1981, 35, 95-111.

### Acid Whey Filtration:

Acid whey samples were provided by a Greek yogurt manufacturer. Filters with a molecular weight cut off (MWCO) of 10 kDa^{26, 27} (Amicon, MilliporeSigma, Burlington, Mass.) and 1 kDa (Pall Corporation, Port Washington, N.Y.) were chosen to model ultrafiltration and nanofiltration respectively. See C. Baldasso, T. Barros and I. Tessaro, Desalination, 2011, 278, 381-386 and G. Konrad, T. Kleinschmidt and W. Faber, International dairy journal, 2012, 22, 73-77.

For ultrafiltration, acid whey was loaded into the 10 kDa filter and centrifuged for 40 minutes at 4200 RPM in a swinging basket rotor in a centrifuge (Thermo Scientific Sorvall ST 16; Waltham, Mass.) with a possible extra 10 minutes at 5200 RPM if there was still a significant amount of acid whey retentate. The ultrafiltration permeate was loaded into the 1 kDa filters and centrifuged at 4000 RCF for 60 minutes to generate the nanofiltration permeate.

For activated carbon pretreatment, an aqueous urea solution or acid whey was added to Cabot brand Norit GAC 300 activated carbon (Cabot Corporation, Boston, Mass.). This slurry was sonicated for 20 minutes to remove the air from the pores. The solution and activated carbon was then stirred at 700 RPM for an hour. Finally, the activated carbon was filtered out of the solution using 0.2 micrometer membrane filters.

What is claimed is:

1. A method of making a solution containing glucose and galactose, the method comprising:
(a) reducing the concentration of non-protein nitrogen-containing (NPN) compounds in a dairy by-product stream comprising lactose to yield a reduced-NPN dairy by-product stream;
(b) contacting the reduced-NPN dairy by-product stream of step (a) with an acid catalyst at a temperature of from about 120° C. to about 200° C., and for a time of from about 1 minute to about 180 minutes, wherein at least a portion of the lactose contained in the reduced-NPN dairy by-product stream is hydrolyzed to monosaccharides comprising glucose and galactose.

2. The method of claim 1, wherein step (a) comprises reducing the concentration of non-protein nitrogen-containing (NPN) compounds in the dairy by-product stream by contacting the dairy by-product stream with an effective amount of an adsorbent dimensioned and configured to adsorb NPN compounds.

3. The method of claim 2, wherein the adsorbent of step (a) comprises activated carbon.

4. The method of claim 2, wherein the adsorbent of step (a) comprises an adsorbent dimensioned and configured to adsorb urea.

5. The method of claim 1, wherein in step (a), the acid is a solid acid or a mineral acid.

6. The method of claim 5, wherein the acid is selected from the group consisting of solid acid-functionalized styrene-divinylbenzene copolymers, solid acid-functionalized tetrafluoroethylene-based fluoropolymer-copolymers, boric acid (H₃BO₃), hydrobromic acid (HBr), hydrochloric acid (HCl), hydrofluoric acid (HF), hydroiodic acid (HI), nitric acid (HNO₃) perchloric acid (HClO₄), phosphoric acid (H₃PO₄), and sulfuric acid (H₂SO₄).

7. The method of claim 1, wherein step (b) comprises contacting the reduced-NPN dairy by-product stream of step (a) with the acid catalyst at a temperature of from about 120° C. to about 180° C.

8. The method of claim 7, wherein step (b) comprises contacting the reduced-NPN dairy by-product stream of step (a) with the acid catalyst for about 1 minute to about 90 minutes.

9. The method of claim 7, wherein step (b) comprises contacting the reduced-NPN dairy by-product stream of step (a) with the acid catalyst for about 1 minute to about 45 minutes

10. The method of claim 7, wherein step (b) comprises contacting the reduced-NPN dairy by-product stream of step (a) with the acid catalyst for about 1 minute to about 10 minutes

11. The method of claim 7, wherein in step (a), the acid is a solid acid or a mineral acid.

12. The method of claim 11, wherein the acid is selected from the group consisting of solid acid-functionalized styrene-divinylbenzene copolymers, solid acid-functionalized tetrafluoroethylene-based fluoropolymer-copolymers, boric acid (H₃BO₃), hydrobromic acid (HBr), hydrochloric acid (HCl), hydrofluoric acid (HF), hydroiodic acid (HI), nitric acid (HNO₃) perchloric acid (HClO₄), phosphoric acid (H₃PO₄), and sulfuric acid (H₂SO₄).

13. The method of claim 11, wherein the acid is selected from the group consisting heteropoly acids, acid resin-type catalysts, meso-porous silicas, acid clays, sulfated zirconia, molecular sieve materials, zeolites, and acidic material on a thermo-stable support.

14. The method of claim 1, wherein step (b) comprises contacting the reduced-NPN dairy by-product stream of step (a) with the acid catalyst at a temperature of from about 140° C. to about 180° C.

15. The method of claim 14, wherein step (b) comprises contacting the reduced-NPN dairy by-product stream of step (a) with the acid catalyst for about 1 minute to about 90 minutes.

16. The method of claim 14, wherein step (b) comprises contacting the reduced-NPN dairy by-product stream of step (a) with the acid catalyst for about 1 minute to about 45 minutes

17. The method of claim 14, wherein step (b) comprises contacting the reduced-NPN dairy by-product stream of step (a) with the acid catalyst for about 1 minute to about 10 minutes

18. The method of claim 14, wherein in step (a), the acid is a solid acid or a mineral acid.

19. The method of claim 18, wherein the acid is selected from the group consisting of solid acid-functionalized styrene-divinylbenzene copolymers, solid acid-functionalized tetrafluoroethylene-based fluoropolymer-copolymers, boric acid (H₃BO₃), hydrobromic acid (HBr), hydrochloric acid (HCl), hydrofluoric acid (HF), hydroiodic acid (HI), nitric acid (HNO₃) perchloric acid (HClO₄), phosphoric acid (H₃PO₄), and sulfuric acid (H₂SO₄).

20. The method of claim 1, further comprising ultrafiltering the dairy by-product stream prior to step (a).

21. The method of claim 20, wherein step (b) comprises contacting the reduced-NPN dairy by-product stream of step (a) with the acid catalyst for about 1 minute to about 90 minutes.

22. The method of claim 20, wherein step (b) comprises contacting the reduced-NPN dairy by-product stream of step (a) with the acid catalyst for about 1 minute to about 45 minutes

23. The method of claim 20, wherein step (b) comprises contacting the reduced-NPN dairy by-product stream of step (a) with the acid catalyst for about 1 minute to about 10 minutes

24. The method of claim 20, wherein in step (a), the acid is a solid acid or a mineral acid.

25. The method of claim 24, wherein the acid is selected from the group consisting of solid acid-functionalized styrene-divinylbenzene copolymers, solid acid-functionalized tetrafluoroethylene-based fluoropolymer-copolymers, boric acid (H₃BO₃), hydrobromic acid (HBr), hydrochloric acid (HCl), hydrofluoric acid (HF), hydroiodic acid (HI), nitric acid (HNO₃) perchloric acid (HClO₄), phosphoric acid (H₃PO₄), and sulfuric acid (H₂SO₄).

26. The method of claim 24, wherein the acid is selected from the group consisting heteropoly acids, acid resin-type catalysts, meso-porous silicas, acid clays, sulfated zirconia, molecular sieve materials, zeolites, and acidic material on a thermo-stable support.

27. The method of claim 1, further comprising nanofiltering the dairy by-product stream prior to step (a).

28. The method of claim 1, further comprising filtering the dairy by-product stream via reverse osmosis prior to step (a).
